(19) United States
(12) Patent Application Publication
(10) Pub. No.: US 2005/0195987 A1
(43) Pub. Date: Sep. 8, 2005

(54) Acoustic system

(76) Inventor: Sung Yeon Kim, Shalin (HK)

Correspondence Address: THOMSON LICENSING INC., PATENT OPERATIONS, PO BOX 5312, PRINCETON, NJ, 08543-5312, US

(21) Appl. No.: 11/064,559

(22) Filed: Feb. 24, 2005

(30) Foreign Application Priority Data
Mar. 2, 2004 (EP) 04300106.4

(51) Int. Cl. H04R 1/02; H04R 9/06

(52) U.S. Cl. 381/89; 381/335; 381/338

(57) ABSTRACT

An acoustic system such as an audio device, comprises an enclosure, and at least two loudspeakers, which are acoustically coupled with the enclosure, and which generate one forward sound wave and one rearward sound wave each. A waveguide section is arranged in the enclosure and acoustically coupled with the loudspeakers, conducting sound waves of the loudspeakers to a sound outlet The loudspeakers are acoustically oriented in the same direction.

### FIELD OF THE INVENTION

The present invention relates to an acoustic system.

### BACKGROUND OF THE INVENTION

An acoustic system of this type is described in U.S. Pat. No. 5,821,471. The acoustic system described produces sounds over a broad range of frequencies and includes an enclosure as well as one or two loudspeakers which are acoustically connected to the enclosure in order to generate, on the one hand, forward directed sounds, and on the other hand, rearward directed sounds. Moreover, a waveguide is provided which is arranged at least partly in the enclosure and which is also connected acoustically with the loudspeakers to define an acoustic path for the rearward directed sound waves.

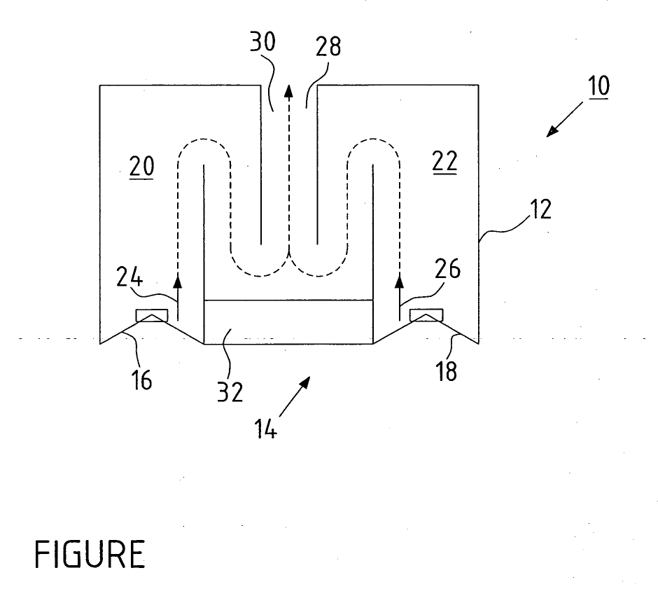

In particular, FIGS. 93, 94, 95 and 96 of U.S. Pat. No. 5,821,471 and the integral description in column 19 disclose the use of two or more loudspeakers which direct their sound waves through the same waveguide to a shared sound opening. This provides for each loudspeaker to have a separate air volume. To reduce the volume of what is referred to as the sub woofer, two small diameter loudspeakers are used instead of one, large diameter loudspeaker, both loudspeakers receiving the same low frequency signal and using the same wave guide.

U.S. Pat. No. 4,628,528 relates to a system for transmitting pressure wave energy. To improve the bass response of a loudspeaker, U.S. Pat. No. 4,628,528 recommends using a waveguide which has the length of a quarter wave length and is designed as a labyrinth.

For audio devices with stereo output and small volumes, U.S. Pat. No. 6,278,789 recommends to feed the low frequency part of the right and left channel to a single loudspeaker, right or left loudspeaker, being provided with a single waveguide. For the optimization of the sound output in view of the loudspeaker characteristics the known arrangement requires advanced equalization of the right and left channel signals. In practice this arrangement requires optimization.

### SUMMARY OF THE INVENTION

Taking the above as its point of departure, the current invention is based on the problem of enhancing an acoustic system of the above specified type in such a manner that the bass response for stereo sound audio devices is improved despite their small size. Balancing the device is also meant to be simplified.

The present invention recommends arranging the loudspeakers in the enclosure in such a manner that they are acoustically oriented in the same direction. This involves using identical loudspeakers and executing an identical signal equalization for both the right as well as the left channel. Contrary to the prior art, one of the loudspeaker is fed with the left stereo signal and the other loudspeaker is fed with the right stereo signal. Furthermore, each loudspeaker is allocated its own waveguide part which, at a sound opening, communicates with a jointly used common waveguide part.

Preferably the waveguide has a shared part at the outlet opening, and two separate parts, each of which leads to one of the loudspeakers. If these parts comprise about ⅓ of the total waveguide volumes, the total effective waveguide volume is about 4/3 of the existing volume. These steps achieve a high quality bass sound for small-size stereo audio devices despite the low amount of volume available. The preparatory treatment or preprocessing of the right and left electrical channel signals is also economically achieved.

A preferred embodiment calls for each loudspeaker to be fed with a left or right channel of the stereo signal.

Further details, advantages, and characteristics of the invention ensue not only from the claims, the characteristics they contain—alone and/or in combination—but only from the following description of one of the preferable embodiments which can be found in the drawing.

### BRIEF DESCRIPTION OF THE DRAWINGS

Preferred embodiments of the present invention will be described below in more detail, with reference to the accompanying drawings, in which:

FIGURE is a schematic top plan view of one embodiment of an acoustic system according to the present invention.

### DETAILED DESCRIPTION OF THE PREFERRED EMBODIMENTS

The present invention provides an acoustic system as illustrated in the only FIGURE showing a purely schematic top plan view of an audio device 10 with stereo sound. The audio device 10 comprises an enclosure 12 in whose front face 14 loudspeakers 16, 18 are arranged which are substantially oriented in the same direction. Loudspeakers 16, 18 are substantially identical loudspeakers which are driven with an identical signal equalization both for the right as well as the left channel.

Each loudspeaker 16, 18 is allocated its own waveguide part 20, 22 which conducts a rearwards, i.e. in the direction of the arrow 24, 26 directed sound, towards a sound opening 28. At the sound opening the individual waveguide parts 20, 22 connect to form one common waveguide part 30. The waveguide parts 20, 22, which are allocated to loudspeakers 16, 18, comprise some ⅓ of the total waveguide volume, the total effective waveguide volume being some 4/3 of the existing volume.

This means that the invention's suggested arrangement of the loudspeakers 16, 18 and the path of the waveguide parts 20, 22, 30 have the overall effect of enlarging the existing volume.

This considerably improves the bass sound of small stereo audio devices despite the small amount of available volume. Thanks to the use of identical loudspeakers and substantially identical signal equalization for both channels, a low-cost preprocessing of the signals for the right and left channel can be achieved.

Finally, it should be mentioned that the enclosure 10 preferably comprises a compartment 32 at the front face 14 in which electronic components such as a CD or cassette tape drive, tuner, or other hi-fi components can be arranged.

In the embodiment shown in the FIGURE, the loudspeakers 16, 18 are oriented towards the front side of the audio device 10 whereas the opening 28 of the common waveguide part 30 is directed to the rear side of the audio device 10. However, in another embodiment of the invention, the orientation of the loudspeakers 16, 18 and the waveguide part 30 is just reversed. In yet another embodiment the loudspeakers 16, 18 and the opening 28 of the waveguide part 30 are directed to the same side.

While foregoing is directed to the preferred embodiment of the present invention, other and further embodiments of the invention may be devised without departing from the basic scope thereof, and the scope thereof is determined by the claims that follow.

1. An acoustic system such as an audio device, comprising:
an enclosure,
at least two loudspeakers, substantially identical to the each other and acoustically coupled with the enclosure, which generate one forward sound wave and one rearward sound wave each,
at least one waveguide section arranged in the enclosure and acoustically coupled with the loudspeakers, conducting sound waves of the loudspeakers to one sound outlet, wherein
the loudspeakers are acoustically oriented in the same direction, and each loudspeaker is allocated its own waveguide part, and that the waveguide parts at the sound opening communicate with a jointly used waveguide part.

2. The acoustic system according to claim 1, wherein one of the loudspeakers is fed with the right channel of a stereo signal and the other one is fed with the left channel of a stereo signal.

3. The acoustic system according to claim 1, wherein one of the loudspeakers is fed with the right stereo signal and the other one is fed with the left stereo signal.

4. The acoustic system according to claim 1, wherein the signal equalization for the right and the left stereo signal is substantially identical.

5. The acoustic system according to claim 1, wherein the portion of the waveguide parts each separately allocated to the loudspeakers comprises approximately 1/3 of the total volume of the waveguide, the total effective waveguide volume being approximately 4/3 of the existing volume.
